(19) United States
(12) Patent Application Publication
(10) Pub. No.: US 2014/0278511 A1
(43) Pub. Date: Sep. 18, 2014

(54) INFORMATION EXCHANGE FOR HEALTH CARE PROVIDERS

(71) Applicant: ZIRMED, INC., Louisville, KY (US)

(72) Inventors: Douglas R. Fielding, Finchville, KY (US); James Scott Lacy, Shelbyville, KY (US); Christopher L. Schremser, New Albany, IN (US); Dustin Wayne Hamilton, Louisville, KY (US); Bethany Ann Williams, Rowlett, TX (US); Eric L. Sinclair, III, Louisville, KY (US)

(73) Assignee: ZIRMED, INC., Louisville, KY (US)

(21) Appl. No.: 14/216,485

(22) Filed: Mar. 17, 2014

Related U.S. Application Data
(60) Provisional application No. 61/788,742, filed on Mar. 15, 2013.

(51) Int. Cl. G06Q 50/22; G06Q 10/10

(52) U.S. Cl. CPC G06Q 50/22; G06Q 10/10
USPC 705/2

(57) ABSTRACT

A method is provided for exchanging healthcare information between a plurality of healthcare providers. The method includes providing a software platform which is prepopulated with the profiles of healthcare providers; assigning a prepopulated profile to a healthcare provider via an authentication process, thus establishing the healthcare provider as a member on the platform; establishing a communication means on the platform which allows a member healthcare provider to (a) communicate with other member healthcare providers via secure messages, and (b) exchange healthcare related documents with each other as attachments to the messages; and creating a network associated with a first healthcare provider on the platform by (a) transmitting an invitation initiated by the first healthcare provider to a second healthcare provider inviting the second healthcare provide to join the first healthcare provider's network, (b) receiving an acceptance of the invitation from the second healthcare provider, and (c) authenticating the second healthcare provider.

### CROSS-REFERENCE TO RELATED APPLICATION

This application claims the benefit of U.S. provisional application No. 61/788,742, filed Mar. 15, 2013, having the same title, and which is incorporated herein by reference in its entirety.

### FIELD OF THE DISCLOSURE

The present disclosure relates generally to healthcare management, and more particularly to systems and methodologies for establishing an information exchange for health care organizations.

### BACKGROUND OF THE DISCLOSURE

The Health Information Technology for Economic and Clinical Health (HITECH) Act provides the Department of Health & Human Services (HHS) with the authority to establish programs for the improvement of health care quality, safety, and efficiency through the promotion of healthcare related information technology (IT). Such healthcare related IT includes electronic health records, and the private and secure exchange of electronic health information. Under HITECH, eligible healthcare professionals and hospitals can qualify for Medicare and Medicaid incentive payments when they adopt certified Electronic Medical Record (EMR) technology (also referred to as Electronic Health Record (EHR) technology), and then use the adopted EMR technology to achieve specified objectives.

A set of standards referred to as “meaningful use” has been defined by the Centers for Medicare & Medicaid Services (CMS) Incentive Programs that govern the use of EMRs. These standards allow eligible healthcare providers and hospitals to earn incentive payments by meeting specific criteria. The goal of meaningful use is to promote the spread of electronic health records to improve health care in the United States. To date, HHS has released regulations which define the meaningful use objectives that providers must meet in order to qualify for the bonus payments. These regulations identify the technical capabilities required for certified EMR technology.

One of the goals for the meaningful use of EMRs is to provide complete and accurate healthcare information. This will ensure that healthcare providers have the information they need to provide the best possible care for patients, and will allow healthcare providers to have a better understanding of their patients and their health history before diagnosis or treatment.

Another goal of the meaningful use of EMRs is to provide better access to healthcare information. The use of electronic health records has the potential to facilitate greater access to the information that healthcare providers need to diagnose health problems earlier, and to improve the treatment outcomes of their patients. The use of electronic health records also has the potential to allow information to be shared more easily among physician offices, hospitals, and across health systems, which in turn may lead to better coordination of healthcare services.

Patient empowerment is also a goal of the meaningful use of EMRs. Electronic health records have the potential to empower patients to take a more active role in their healthcare and in the healthcare of their families. In particular, EMRs provide the ability for patients to receive electronic copies of their medical records and to share their health information securely (over the Internet or via other networks) with their families.

### BRIEF DESCRIPTION OF THE DRAWINGS

FIG. 1 is an overview illustration of an embodiment of the platform disclosed herein.

FIG. 2 illustrates a method for exchanging information between healthcare providers across the platform of FIG. 1.

FIGS. 3-25 are screenshots from a particular, non-limiting embodiment of a software platform in accordance with the teachings herein.

### SUMMARY OF THE DISCLOSURE

In one aspect, a method is provided for exchanging healthcare information between a plurality of healthcare organizations. The method comprises (a) providing a software platform which is prepopulated with the profiles of healthcare providers; assigning a prepopulated profile to a healthcare provider via an authentication process, thus establishing the healthcare provider as a member on the platform; (b) establishing a communication means on the platform which allows a member healthcare provider to (i) communicate with other member healthcare providers via secure messages, and (ii) exchange healthcare related documents with each other as attachments to the messages; and (c) creating a network associated with a first healthcare provider on the platform by (i) transmitting an invitation initiated by the first healthcare provider to a second healthcare provider inviting the second healthcare provide to join the first healthcare provider's network, (ii) receiving an acceptance of the invitation from the second healthcare provider, and (iii) authenticating the second healthcare provider.

### DETAILED DESCRIPTION

Unlocking and sharing patient information across the provider continuum is critical for healthcare providers to gain meaningful cost savings and to provide promised patient care benefits. However, despite the HITECH and Meaningful Use incentives and the adoption of EMR technologies, in practice, the goal of allowing patient information to be easily shared between healthcare providers has still not been realized. This problem is due, in part, to the lack of an easy and secure means by which healthcare providers can share patient healthcare information and records. As a result, and counter to the intention of these incentives and technologies, at present, patient information tends to remain locked away in individual silos associated with particular healthcare providers.

It has now been found that the foregoing needs may be met with the systems and methodologies disclosed herein. In a preferred embodiment of these systems and methodologies, a software-as-a-service (SaaS) platform is provided which is associated with a Revenue Cycle Management Company (RCMC) and which can harness the power of the connected network of healthcare providers associated with the RCMC, thereby facilitating secure provider-to-provider communications from any EMR or information management system via the platform.

The platform is preferably a HIPAA-compliant, provider-to-provider communication platform which is accessible by the clients of the RCMC. In a preferred embodiment, the system enables authenticated users to invite their referral network to join the secure network and to easily exchange information. The platform enables providers to communicate directly with one another via secure messaging functionality, as well as to transfer administrative and vital clinical information via structured or unstructured data as attachments.

In addition to serving as a secure email system, the platform is also a workflow automation system that enables providers to eliminate phone, fax, and mail currently used for referrals and patient transition of care, and can avoid HIPAA compliance issues associated with standard email and dated processes. The platform may also avoid questions arising from mailing a chart or faxing paperwork, since it allows the healthcare provider to merely point, click and send information and documents.

Unlike Health Information Exchanges, the platform disclosed herein allows providers to easily transition patients and clinical documents between healthcare settings without having the complex implementation of expensive and cumbersome architecture and point-to-point interfaces. Rather than relying on installed software and point-to-point integrations, the platform is preferably a fully web-based solution which is system agnostic and which does not require major technical integrations. The platform's framework is based off a social network approach that reaches a broader base of providers, regardless of their IT budget, infrastructure, and the technologies they have in place.

In a preferred embodiment, the platform is a user-driven, invitation opt-in network, as opposed to a top-down heavy implementation solution. The platform is also preferably pre-populated with provider information, thus allowing healthcare providers to simply authenticate and claim their profile, and then begin exchanging secure vital clinical information.

In a preferred embodiment, the platform provides for the coordination of several different types of patient healthcare information. These include: (a) clinical information exchanged between providers, in both structured and non-structured forms; (b) insurance and demographic information necessary to transfer the patient from one healthcare setting to another; (c) clinical information generated during HIPAA transactions; and (d) financial and administrative information, such as claims and eligibility information.

The platform described herein has several notable advantages. One such advantage is that it facilitates a user (typically a healthcare provider) in setting up a sharing network. The user can readily add a physician or hospital to their network by simply choosing the entity of interest, and then clicking on a hyperlink to send them an invitation to join their network. Once the invitee accepts the invitation, the user will be able to exchange patient information and clinical documents, track and verify the receipt of files, and provide additional patient care information in the notes. The platform also provides a simple utility for finding and adding the healthcare providers that a healthcare entity refers patients to/from the provider's network. In particular, an “easy invite” search feature is provided that allows other providers to grow a provider's network by finding providers that are in a specific affiliation, specialty, service, or geographic area.

The platform also provides a clear and simple means of communication between healthcare providers. When a need arises for a first provider to communicate with a second provider about a patient or clinical document, the first provider simply clicks a hyperlink to create a referral/case, or simply adds a note to an existing referral/case. The platform provides instant communication that is recorded and tracked, allowing the first provider to confirm receipt by the second provider without spending time on the phone.

The platform also provides work management functions that allow healthcare providers to minimize paperwork and prioritize tasks. In particular, the platform provides a robust, sortable work list that compiles patients being sent and/or received for care.

The platform also provides the conveniences associated with a web-based system. Thus, in a preferred embodiment, a healthcare service provider needs only a computer and Internet or web access to begin using the platform. There is nothing to install, nothing to maintain, and no long, protracted implementation process or contracts.

The platform also provides a means to comply with the requirements of Meaningful Use Stage 2 (MU2) for the transition of patient care by facilitating digital document exchange across practices. The platform also provides a document repository. In particular, the platform stores all the documents sent and received for easy viewing and retrieval with a variety of easy search options.

The platform also provides automated task tracking and notes, and thus reduces or eliminates lost documents. In particular, the platform alerts the user when a digital package is viewed by a recipient. Indeed, all activity within the platform is automatically tracked and noted for the user. This allows the user to easily see who has read the information, and if the documents were accepted by a recipient.

The platform also allows users to stop leaving phone messages and to start sending digital notes. In particular, when a user needs to communicate with another provider about a patient or clinical document, the user can simply add a note. This instant communication is recorded and tracked, thus allowing the user to confirm receipt without spending time on the phone.

In a preferred embodiment, each user may be associated with, and perform tasks for, one or more entities. The user can manage the entities that they perform tasks for (such as, for example, adding, updating or deleting information). When adding an entity, the user can search for a provider via national provider identifier (NPI) (this is a unique ten-digit identification number required by HIPAA for all health care providers in the United States), and the system will automatically populate profile information for that entity from the NPPES database. The user may also manually add an entity.

Each entity, which may be an organization or an individual, has a profile or attributes that describes them. This profile preferably includes, but is not limited to, information about the entity, such as contact information and social connections (e.g., Facebook or LinkedIn accounts or connections).

A user of the platform disclosed herein may establish connections, for each entity they act on behalf of, with various other entities with which they exchange healthcare information. The platform is preferably equipped with a searching functionality that the user can utilize to search for external entities, each of which has a profile that describes them. The searching functionality is equipped with various search parameters that allow the user to narrow a search to those entities that reside within a given distance of a particular zip code, that have a particular specialty, or that are associated or affiliated with a particular group. The search may also extend to all healthcare providers, or may be limited to those with which the user has existing connections.

The platform disclosed herein is also preferably equipped with an invitation means by which the user can invite other entities to connect with them. This invitation means is preferably implemented as a button or other hotlink (preferably entitled “Invite to <RCMC name>”), the selection of which launches a subroutine by which an invitation is sent to the desired healthcare provider inviting the provider to connect with the user.

As part of this subroutine, the system looks to see if the invited healthcare provider is already affiliated with the RCMC (that is, the system checks to see if the healthcare provider has one or more accounts with the RCMC), preferably by looking to see if that provider's NPI is seen on transactions within the RCMC's system. If it is determined that the invitee is already affiliated with an account with the RCMC, then the inviting user is presented with a screen indicating that the provider may already have an account with the RCMC, and the account information is shown. If more than one account is identified, the user is asked to select the account with which they wish to engage.

The user may elect to invite the provider via one of the already established accounts, or as a completely separate entity from the accounts displayed. In a preferred embodiment, the user is asked to supply the email address of another user who is associated with the desired connection entity, along with a fax number of the desired connection. The user associated with the desired connection entity is then authenticated via a fax authentication process. After successful authentication, the invitation is then sent via email.

When an external Entity receives an invitation to connect, the invitation comes via email to an individual with the email address supplied by the inviting user. If the invitation was extended to an entity with an existing account with the RCMC, then the Domain Administrator (DA) for that account also receives an email invitation to connect. The recipient can select a link in the email to view the details of the invitation, after which the recipient is presented with information about the service such as, for example, description and pricing options. The recipient may then accept the invitation by selecting a “Sign-Up” button associated with one of the pricing options.

For invitees that already have an account on the system, the recipient is presented with a screen asking them to confirm that they have authority for their organization to sign-up for the service and to commit to the monthly charge. The recipient is then taken to the system dashboard page, where they will be able to see any other outstanding invitations to connect and any work items sent to them from the initial connection.

For recipients that do not already have an account on the system, the recipient is presented with a page that explains the fax authentication process to ensure proper identity and security. The recipient is invited to begin the authentication process by selecting a button or other hyperlink to have an authentication code faxed to them. After making this selection, the recipient is presented with a screen advising that a fax is on its way with the authentication code, and is instructed to enter the authentication into the confirmation screen once received. The RCMC then sends a fax to the fax number supplied by the sending user when initiating the connection. Fax contains the authentication code.

Upon receiving the fax containing the authentication code, the fax recipient enters the authentication code from the fax into the appropriate field on the confirmation screen and clicks a button or hyperlink entitled “Verify”. The connection is then authenticated. The fax recipient is presented with a screen to finalize their selected plan and to provide initial set-up information like user profile and primary location information. The fax recipient is then presented with the opportunity to invite other providers to connect to them, using the process described above. The fax recipient is also presented with the opportunity to add other users to this account. The fax recipient is then presented with a final screen in which they are asked to confirm the account information, agree to Terms and Conditions, and press “Submit and Create Account”. Upon selecting this button, the account is created. The fax recipient is then taken to the system dashboard page, where they will be able to see any other outstanding invitations to connect and any work items sent to them from the initial connection.

In a preferred embodiment, a user's work tasks are managed via a Work List. The items on the Work List are divided between inbound work and outbound work. The platform preferably supports custom workflow rules and templates, which may be specific to transaction types. Workflow rules and templates may be relationship-specific, and workflow may be established for each direction in an exchange.

A user may view submitted outbound work items. In order to view outbound work items, the user clicks on an “Outbound” tab to view outbound work items. The user may edit or enhance any work item, and preferably, both the sender and receiver are able to view any changes.

A user may create a new outbound work item. To do so, the user selects a “Create Referral” hyperlink. The user is then able to supply patient information for the outbound work item, insurance information for the patient, and an unlimited number of insurance sequences. The user can specify the home entity from which they are sending the outbound work item, and may also specify the entity to whom they are sending the outbound work item. The recipient entity may be a home entity or an external entity.

A user may also search for entities on the platform. Searching may be done on the basis of name, NPI, distance, specialty, group, or affiliation. The user can select an entity from the results of the search. The user can also supply encounter information, such as reasons, procedures, schedule date, schedule time and duration.

The user can also supply notes and add attachments. Such attachments may be of any binary file type, and may be attached via manual upload. The user may save an unsent outbound work item as draft, and may submit the outbound work item.

Inbound work items may have eligibility automatically checked, and the user may view received inbound work items. The user clicks on an “Incoming” tab to view inbound work items. The user can search or view such fields as status, scheduled date, received date, referred from, referred to, patient name, and attachments indicator.

The user may take various actions on a received inbound work item. Thus, for example, the user may select a record to view it and take appropriate action, the user can view such fields on the inbound work item such as sender, receiver, attachments, patient information, insurance information, encounter information, and notes. The user may also check eligibility for the patient using supplied insurance info, add a note, and edit or print a record.

The user may also accept or decline an inbound work item. Preferably, accepted items land in the receiver's inbox and are marked as accepted. Declined items are returned to the sender marked as declined, with decline reason captured and reported.

The platform disclosed herein may generate various notifications. These notifications are available for various events, such as new work items, new connection requests, connection acceptances, connection declines, work item declines, workflow reminders, and updates to work items. The notifications preferably have an associated configurable delivery model, with associated parameters such as frequency, summary/detail, and activity types. The notifications preferably also have associated configurable delivery methods, which may include email and text.

The platform disclosed herein may be equipped with various analytical functions. These may include referral denial analysis reporting, network connections performance/cycle time reporting, provider referral network breakdown reporting, referral mapping, and user performance metrics.

The platform disclosed herein may also utilize patient notebook integration. This may involve enrolling a patient in the patient notebook, sending or courtesy copying health information to patient, and engaging the patient in the process.

The platform disclosed herein is also preferably equipped with a patient directory. This directory be automated via Health Level 7 (HL7) feed from external systems (HL7 is a non-profit organization involved in the development of international healthcare informatics interoperability standards). The directory may also be equipped with auto suggest for form completion, and may be maintained with respect to dynamic data exchange (DDE).

The platform disclosed herein is also preferably equipped with suitable functionality for data export. This functionality may support exports in CSV (comma separated values), XML (extensible markup language), or text file formats, and may be exposed via publicly-accessible application programming interfaces (APIs).

FIG. 1 provides an overview of a preferred embodiment of the systems and methodologies described herein. As seen therein, the system 101 (sometimes referred to herein as the Clinical Link™ healthcare information exchange system) provides a means by which a first healthcare provider 103 can securely exchange information 105 (such as, for example, patient demographic and insurance information, laboratory and test results, and clinical documentation) with a second healthcare provider 107 over a network 109 by way of a HIPAA-compliant, online platform 111. The information exchanged over the platform 111 is accessible only by personnel associated with the first 103 and second 105 health care providers.

As seen in FIG. 2, in a preferred embodiment of the systems and methodologies disclosed herein, exchanging information over the platform is a simple process 151 that merely involves selecting a patient to be referred 153, adding any attachments 155 (which may be, for example, any of the items 105 of FIG. 1), and choosing recipient 157. The platform then manages the exchange of information in a secure, HIPAA-compliant manner.

FIGS. 3-25 illustrate a first particular, non-limiting embodiment of a software program in accordance with the teachings herein.

With reference to FIG. 3, the software includes a menu bar 201 which is accessible from each working screen in the software. Preferably, the menu bar floats on top of, or does not overlap with, the windows used by a user to interact with the software.

The menu bar 201 includes a plurality of pull-down menus 203 that allow the user to navigate to various screens of interest in the software program. In the particular embodiment depicted, these include menus which allow the user to manage their account, work with professional claims (e.g., claims for professional medical services being processed by the user), work with institutional claims (e.g., claims submitted to an insurance companies or other institutions), work with remits (e.g., payments received on insurance claims), determine insurance eligibility, print documents, use Z Pay™ (an online payment system available through the software), obtain or generate cost estimates (e.g., expected costs for healthcare services), provide patient access (e.g., interact with patients using the PatientNotebook™ system), use analytical tools (e.g., various tools which allow the user to analyze various aspects of their referral network and revenue cycle activities), and use Clinical Link™ (a solution for the secure exchange of healthcare communications).

The menu bar 201 further includes a series of topical hyperlinks 205 that allow the user to navigate to pages (described in greater detail below) in the software program that deal with particular topics such as, for example, creating or viewing a work list, managing or viewing the user's connections, managing the providers which have connections to the user or the user's employer, generating reports, or adjusting various software settings.

The menu bar 201 also includes other navigational aids. These include a “Support and Training Center” tab 206, the selection of which allows the user to navigate to instructional materials that teach the user how to use the software, and also offers information the user may utilize to obtain technical support. These navigational aids also include an account tab menu 207, which allows the user to toggle between different accounts; a user field 209, which identifies the user currently logged into the software; a log off/login hyperlink 208, which allows the user to respectively exit or login to an account; and a payment button 210 entitled “ZPay”, which accesses the Z Pay™ system (an online payment system which is available through the software).

The software, upon launch, preferably presents a dashboard screen 211. The dashboard screen has a software plug 213 located centrally thereon which may include promotional text and graphics. In the particular embodiment depicted, the software plug 213 includes a brief description 215 of what the software does, and includes an accompanying illustration 217. The plug 213 in this particular embodiment further includes highlights 219 which highlight some of the advantages of the software program. These highlights 219 may include hyperlinks to allow the user to navigate to pages which present further information on topics of interest to the user.

The dashboard screen further includes a welcome tab 221. The welcome tab 221 in this particular embodiment identifies the current user, and is equipped with a hyperlink entitled “Take a Tour” which, upon selection, launches a product overview that highlights some of the features of the software program.

The dashboard screen also includes an action center 223. The action center 223 contains a series of tabs or hotlinks that allow the user to take various actions relating to patient referrals to other healthcare providers, among other actions. For example, upon selection, the tab entitled “Create Referral” 225 launches a subroutine which collects from the user all of the information necessary to create a referral to a healthcare provider (this process is described in greater detail below). Other tabs allow the user to work with referrals that are in various stages of creations. These include an “Accepted” tab 227, the selection of which allows the user to view and work with a listing of accepted referrals; an “Awaiting Approval” tab 229, the selection of which allows the user to view and work with a listing of referrals that have been sent out but are awaiting approval by the recipient; a “Declined” tab 231, the selection of which allows the user to view and work with a listing of referrals that have been declined (here, it is to be noted that referrals are often declined simply because more information is needed before the recipient can determine whether or not the referral should be accepted); a “Drafted” tab 233, the selection of which allows the user to view and work with a listing of referrals that have been drafted or are in the process of being drafted, but have not yet been sent; and an “All” tab 235, the selection of which allows the user to view and work with all of the foregoing categories of referrals.

The dashboard screen also includes a “Search Work List” 241 window which allows the user to perform searches on the database of referrals that the user has made (FIG. 4 provides an example of search results). As seen therein, the “Search Work List” 241 window provides fields for the user to tailor a search by specifying such parameters as the scheduled date for the referral appointment; an updated date that represents the most recent date that the referral records had an update; the sender; the receiver; the name of the patient; or the patient's date of birth. The “Search Work List” 241 window thus allows the user to view, for example, all records that have been updated within the last two weeks, or all records for a referral sent to a particular healthcare provider. Of course, it will be appreciated that variations of this embodiment may be produced which allow for searches based on other parameters, either in addition to or (partially or wholly) in place of the foregoing parameters.

FIG. 4 depicts an example of a results screen 243 that would be obtained by selecting “All” in the “Search Work List” 241 window of FIG. 3. As seen in FIG. 4, in the particular example depicted, this search obtained 267 results. The results screen 243 tabulates the results so that, for each referral, several fields are provided beneath a row of correspondingly named headers 245. These include the status of the referral, the scheduled date of the visit to the referred physician or service provider, the name of the patient who was referred, the patient's date of birth, the name of the party who made the referral, the name of the party to whom the referral was made, an attachment field which depicts an icon (in this case, a paperclip) to indicate whether any documents are attached (such as medical records) which relate to the referral, the date on which the referral information was most recently updated, and a hyperlink entitled “Notes” which, upon selection, opens any notes created which relate to the referral, and allows the user to create new notes.

The results in the results screen 243 of FIG. 4 may be organized or reorganized in a variety of ways by selecting the header of the field that is to be prioritized. The results in the results screen 243 are then reorganized by order of the field so selected. For example, selecting the “Updated” field arranges the results in chronological order based on the date of the latest update. Similarly, selecting the “Patient” field rearranges the results in alphabetical order from A to Z. In some embodiments, selecting the “patient” field a second time in succession will reorganize the results in the opposite alphabetical order (i.e., from Z to A).

Notably, the results screen 243 of FIG. 4 contains a “Referrals” tab 245 and a “Secure Messages” tab 247. The “Referrals” tab 245 is pre-selected when the results screen 243 is initially rendered, thus causing the results screen 243 to be displayed. Selection of the “Secure Messages” tab 247 causes the secure messages screen 249 of FIG. 5 to be displayed. The user may use the “Referrals” tab 245 and a “Secure Messages” tab 247 to toggle between these two screens.

As seen in FIG. 5, the secure messages screen 249 is a messaging platform that may be utilized to exchange messages between users of the software. It is equipped with a side menu 251 equipped with tabs that allow the user to browse folders or access messaging functionalities. The latter include the user's inbox, sent messages, and message archive. Selection of any of these items causes the corresponding pane 253 to be rendered in the main portion of the window. The user's inbox is rendered in pane 253 by default, as depicted in FIG. 5.

The inbox lists all messages created by the user's organization. The inbox tabulates the results so that, for each message, several fields 255 are provided beneath a row 257 of correspondingly named headers. The fields 255 include a “Created By” field which indicates the party that created the message, a “To” field which indicates the recipient of the message, a “Subject” field which indicates the subject matter of the message, an attachment field (indicated by the paperclip icon) which indicates whether the message includes any attachment, and a “Received” field, which indicates the date on which the message was received.

A numerical designation 259 is also provided next to the “Received” field which indicates the number of updates that have been generated with respect to the referral since the referral was last viewed or worked on. Hence, this numerical designation highlights which referrals have been active recently, and which may need attention.

FIG. 6 depicts a referral creation window 261 that is launched when the user selects the “Create Referral” tab 225 in the windows of FIG. 3 or 4. As seen therein, this window contains various fields which may be required to create a referral. These include a sender field 263 (that is, the party or organization making the referral), receiver information 265 (that is, the party or organization to whom the referral is directed). Upon entering a name into the sender field 263, the software performs a search of healthcare service providers associated with the user, and generates a pop-up list from which the user may make a selection. For example, entering “Smith” into this field would generate a pop-up list of all healthcare service providers associated with the user having the name “Smith”.

Similarly, upon entering a name into the receiver field 265, the software performs a search of healthcare service providers in the user's network, and generates a pop-up list from which the user may make a selection. An advanced search hyperlink is provided in the receiver field 265 that launches an advanced search window 267 (see FIG. 8) in which the user can specify further search parameters to narrow the query.

The referral creation window 261 further includes a patient information section 269 which includes several fields for input of patient information. This includes, for example, the patient's date of birth, the patient's first, middle and last name, the patient's gender, the patient's social security number, the patient's address (including the patient's street address, zip code, and city and state of residence), and the patient's contact information (including email address and home, work and mobile telephone numbers).

An “Add” button 271 is provided on the referral creation window 261 for the author to add attachments to the document. These may include, for example, any medical records necessary for the recipient to determine whether they wish to accept the referral. Selection of the “Add” button 271 launches a window from which the user can browse to folders containing the documents to be attached. Hence, the “Add” button 271 provides a convenient means for exchanging documents without faxing them (as was standard in the prior art).

The referral creation window 261 further includes an insurance section 273 which includes several fields that permit the user to input insurance information. This includes, for example, the name of the payer, their contact number, the name of the subscriber, the insurance ID number, and the insurance group number. The insurance section 273 further includes a subscriber pull down menu which allows the user to describe the patient's relation to the subscriber.

The insurance section 273 also includes a verification window, which allows the user to indicate whether insurance coverage has been verified and, if so, the date on which verification occurred. Similarly, the insurance section 273 also includes an authorization window, which allows the user to indicate whether insurance coverage has been authorized and, if so, the date on which authorization was given and the associated authorization code.

A “Remove Insurance” hotlink 275 is also provided in the insurance section 273, the selection of which clears all of the fields in that section. This provides an expedient means of modifying the referral in the event that the entered insurance information is deemed to be outdated or incorrect.

The referral creation window 261 also includes referral disposition tabs 277. These tabs allow the user to send the referral, save it as a draft, or cancel the referral.

FIG. 7 depicts the message window 279 which is launched when the “Create Message” tab 281 of FIG. 5 is selected. As seen therein, the message window 279 provides fields common to electronic messaging, such as an identification of the sender and the recipient, a subject field into which the subject of the message may be entered, and a message field into which the body or text of the message may be entered. An attachment button is provided which, upon selection, allows the user to browse to a folder containing a file they wish to attach to the message. Send and cancel buttons are also provided which, upon selection, respectively send or cancel the message. Messages exchanged via the software are preferably encrypted for security using suitable encryption protocols.

As noted above with respect to FIG. 6, an advanced search hyperlink is provided in the receiver field 265 that launches an advanced search window 267 in which the user can specify further search parameters to narrow the query. The advanced search window 267 is depicted in FIG. 8. As seen therein, the advanced search window 267 is equipped with a search bar 283 which enables the user to find healthcare providers by an identifier and/or by proximity to a specified location. The identifier may be, for example, the last name of a person, the name of a facility (e.g., “Acme Orthopedics”), or a National Provider Identifier (NPI)(a unique 10-digit identification number issued to health care providers in the U.S. by the Centers for Medicate and Medicaid Services (CMS)).

The advanced search window 267 is also provided with a filter 285, which allows the user to search for healthcare providers based on their specialty (e.g., orthopedics), account or affiliation. This filter 285 may be used in conjunction with the search bar 283.

Upon entry of search parameters, the advanced search window 267 generates a listing of results 287. Each result preferably includes a main pane 289 which identifies the name, address, group affiliation, phone and fax number of the provider, as well as an indication of the proximity (preferably in miles) to the user or the location of an entity that the user is affiliated with. Each result preferably also includes an auxiliary pane 291 which indicates whether the provider is in the user's network (or in the network of an entity the user is associated with), and provides a hot link which, when selected, allows the user to view a profile of the healthcare provider.

Preferably, by default, the advanced search window 267 is set to conduct searches on the user's connections. In the embodiment depicted, this default search window is associated with a tab entitled “My Connections” 293. However, if the user wishes to search for healthcare providers in general (i.e., including those outside of the user's network), the user may select a tab entitled “Find Providers” 295 [Is this correct?]. Selection of the “Find Providers” 295 tab launches a search window which is similar to that depicted in FIG. 8, but which searches all healthcare providers, not just those in the user's network.

Frequently, when a suitable healthcare provider for a particular referral is not already in a user's network, the user may wish to add a suitable healthcare provider to their network. This may be accomplished by selecting the “Find Providers” 295 tab in the advanced search window 267 of FIG. 8, conducting a search in the search window that is subsequently launched, and selecting the “My Connection Requests” tab 297 when the healthcare provider of interest is highlighted in the search window (the search results are displayed as a scrollable listing similar to that in FIG. 8, and in which the topmost item in the portion of the listing being viewed is highlighted). This will launch the editable pop-up window 301 depicted in FIG. 9, which floats over the search results and includes the details of an invitation addressed to the desired healthcare provider. The pop-up window 301 includes the name of the party to whom the invitation is addressed, as well as several fields that are prepopulated with the contact information of the party extending the invitation.

The software also provides a means by which a user's contacts may be managed. In particular, upon selection of the “Manage My Providers” hyperlink in the topical hyperlinks 205 (see, e.g., FIG. 3), the “Manage My Providers” window 303 depicted in FIG. 10 is launched. The main portion 305 of this window contains a listing of the names and specialties of all healthcare providers that the user is currently connected to (the number of such providers is also indicated above this listing). By default, the listing is provided in alphabetical order, a result which may also be obtained at any time by selecting the name 307 header in the listing. Conversely, selecting the specialty header 309 will reorganize the listing by specialty.

A healthcare provider may be added to the user's connections by selection of the “Add Provider” tab 311. The “Add Provider” tab 311 launches the search window shown in the background of FIG. 9, and hence functions in the same manner as the “Find Providers” tab 295 of FIG. 8.

FIG. 11 depicts a referral profile 313 available on the system. This profile is opened when a user selects one of the healthcare providers from the list in the “Manage My Providers” window 303 of FIG. 10. In the particular embodiment depicted, the referral profile 313 includes a thumbnail 315 of the profiled party, which includes a photo, the name of the party and the entity they are associated with, their specialty, and their phone number. Edit or clear hotlinks are provided in the thumbnail 315 which allow an authorized party to respectively edit or clear the photo. Indicia 317 are provided next to the thumbnail 315 which indicate whether the profiled party is connected to the user (that is, is a member of the user's network via the software), and whether the profiled party is a member of the exchange established by the software.

The referral profile 313 further includes an overview section 319 which provides an overview of the healthcare provider's practice, a contact section 321 which provides contact information for the healthcare provider, an affiliations section 323 which specifies any affiliations the healthcare provider has, a provider information details section 325 which indicates the specialty of the profiled party and their NPI, and an insurance section 327 which indicates the types of insurance the profiled party accepts.

FIG. 12 illustrates the creation of a profile. A profile may be created by a user, or a person or entity that the user is associated with the user. However, as noted above, in a preferred embodiment of the systems and methodologies described herein, an initial profile of a healthcare provider is generated by the software and is subsequently claimed by the user to which it corresponds. Hence, as part of this process, the user is presented with the opportunity to edit or update a profile they are associated with at the time the software.

The foregoing is accomplished through the profile creation screen 329 depicted in FIG. 12, which prompts the user for all of the types of information set forth in the profile 313 of FIG. 11. Appropriate buttons 331 are provided which allow a user to save, cancel or delete a profile after it is created. The profile creation screen 329 is typically launched as part of the software set-up operation, and may also be accessed through the “Settings” link in the topical hyperlinks 205 portion of the menu bar 201 (see FIG. 3).

The systems, methodologies and software disclosed herein also preferably provide various reporting functionalities. In the embodiment depicted, these functionalities are accessed from the “Reports” link in the topical hyperlinks 205 portion of the menu bar 201 (see FIG. 3), which launches the reports window 331 depicted in FIG. 13. The reports window includes a reports menu 333 on the left-hand side from which various types of reports may be selected. As seen in FIGS. 13-19, the corresponding reports are displayed in the pane to the right.

In the instance depicted, the “Overview” report 335 is displayed. This report indicates the number of referrals sent and received in the most recent time interval (typically monthly, though this interval may be set by the user in the software settings). It also provides an historical comparison for these numbers.

FIG. 14 illustrates the “Activity Summary” report 337. This report provides a table 339 of data which indicates the number of referrals sent and received in the relevant time interval, and also indicates the current disposition of those referrals. In particular, the table 339 indicates the account the referrals were associated with, the number of referrals for each account that have been accepted or declined, the number of referrals for each account that require a response, and the total number or referrals for each account that were sent or received.

The time interval for the report may be set by the user in the reporting period tab 341 above the table 339. The reporting period tab 341 includes an “Update Reporting Period” button 343 which may be utilized after a different reporting period has been specified, or which may be utilized to update a previously prepared report to reflect additional or modified data.

FIG. 15 illustrates the window 345 launched when the user selects “Export Referral Details” from the reports menu 333. As with the “Activity Summary” report 337 depicted in FIG. 14, a reporting period tab 347 is provided which allows the user to set the time interval for these reports, and which also allows the user to specify whether the generated report will pertain to received or sent referrals. A details report section 349 is also provided which includes several selectable search parameters, any or all of which may be selected. These search parameters may be utilized to limit the report to specific patient parameters (such as, for example, name or social security number), sender parameters (such as, for example, facility name or NPI), general parameters (such as, for example, creation date or number of attachments), receiver parameters (such as, for example, receiving facility name or NPI), and encounter parameters (such as, for example, procedure codes or scheduled date).

An “Export Details” tab 351 is provided which allows a report generated with the selected parameters to be exported (e.g., to a party to whom a referral is made). Similarly, an “Export Insurance” tab 353 and “Export Notes tab 355 are provided to allow insurance information and notes, respectively, to be exported.

FIG. 16 illustrates the “Received Referral Summary” report 357. This report provides a graphic illustration 359 of the number of referrals received, either by provider or by account. As with the “Activity Summary” report 337 depicted in FIG. 14, a reporting period tab 361 is provided which allows the user to set the time interval for these reports. The reporting period tab 361 includes an “Update Reporting Period” button 363 which may be utilized after a different reporting period has been specified, or which may be utilized to update a previously prepared report to reflect additional or modified data.

FIG. 17 illustrates the “Sent Referral Summary” report 367. This report provides a graphic illustration 369 of the number of referrals received, either by provider or by account. As with the “Activity Summary” report 337 depicted in FIG. 14, a reporting period tab 371 is provided which allows the user to set the time interval for these reports. The reporting period tab 371 includes an “Update Reporting Period” button 373 which may be utilized after a different reporting period has been specified, or which may be utilized to update a previously prepared report to reflect additional or modified data.

FIG. 18 illustrates the “Decline Reason Summary” report 375. This report provides a graphic illustration 377 of the reasons referrals were declined. In the particular embodiment depicted, the graphical illustration 377 is in the form of a pie chart with entries for “Insurance Not Accepted”, “Scheduled Time Not Accepted”, “Not Accepting New Patients”, “Additional Information Required”, and “Other”. The number of referrals to which each entry in the pie chart applies is indicated numerically in the associated color key 379. It will be appreciated that this graphical depiction enables the user to quickly understand the primary reasons why referrals are being declined, and to take corrective action.

As with the “Activity Summary” report 337 depicted in FIG. 14, a reporting period tab 381 is provided in the “Decline Reason Summary” report 375 which allows the user to set the time interval for these reports. The reporting period tab 381 includes an “Update Reporting Period” button 383 which may be utilized after a different reporting period has been specified, or which may be utilized to update a previously prepared report to reflect additional or modified data.

FIG. 19 illustrates the “Outstanding Sent Referrals” report 385. This report is in the form of a table which identifies the party that received of the referral, the number of referrals that party received that require a response, and the age (in days) of the oldest referral sent to that party.

FIG. 20 illustrates the notification settings window 387 which is launched when the user selects the “Settings” hyperlink in the topical hyperlinks 205 of the menu bar 201. This window allows the user to change the settings that govern when notifications are sent to the user. The independently selectable settings include an option to receive a notice when the user's account is sent a connection request, when a party accepts a connection request sent by the user, when a party declines a referral sent by an account associated with the user, and when a party sends a referral to an account associated with the user. A Notifications/Referrals menu 389 is provided which allows the user to toggle between the notifications settings window 387 and the referrals settings window 391 (see FIG. 21).

The referrals settings window 391 is depicted in FIG. 21. As seen therein, the referrals settings window 391 provides a patient information section 393 and an insurance section 395, each of which contains fields that the user can require or set as optional when receiving referrals. If the user sets a specific field as required, then that field will show up on the referral form presented by the software to another party that wishes to make a referral to the user, and the referring party will be unable to send the referral until the required field has been completed. If the user sets a specific field as optional, then that field will show up on the referral form presented by the software to another party that wishes to make a referral to the user, but the referring party will be able to send the referral even if the optional field has not been completed. If the user does not check (or unchecks) a specific field, then that field will not show up on the referral form presented by the software to another party that wishes to make a referral to the user. The referrals settings window 391 also allows the user to enable or disable an account from receiving referrals.

FIG. 22 illustrates an example of a first referral form 401 generated in the system described herein in which the user is the sender of the referral. As seen therein, the referral form 401 contains a sender/receiver section 403 which identifies, respectively, the party that made the referral and the party that received the referral. The referral 401 also contains a patient information section 405 in which the party making the referral provides information about the patient being referred, an attachments section 407 in which the party making the referral can attach supporting documents thereto, and an insurance section 409 in which the party making the referral can provide insurance information for the patient. This particular referral 401 has been declined by the recipient, a fact which is indicated by a (preferably color-coded) header 411 at the top of the referral 401.

Notably, the referral form associated with the receiver (and presented to the user) in this example has required in the patient information section 405 that the fields relating to the patient's date of birth (DOB), last name and first name be completed, a fact indicated by the use of asterisks in the associated field names. Other fields, such as middle name, gender and social security number, are merely optional.

FIG. 24 illustrates an example of a second referral form 421 generated in the system described herein in which the user is the recipient of the referral. Hence, the referral form 421 is how that form appears to the party making the referral. FIG. 23 shows the corresponding referral 431 as it appears to the user. FIG. 25 shows the referral 451 after it has been accepted and saved by the user.

As seen in FIG. 23, the referral 431 mirrors the referral form 421, and hence contains a sender/receiver section 433 which identifies, respectively, the party that made the referral and the party that received the referral. The referral 431 also contains a patient information section 435 which provides information about the patient being referred, an attachments section 437 which includes any attachments made to the referral 431, and an insurance section 439 which provides insurance information for the patient. This particular referral 431 has been accepted by the recipient, a fact which is indicated by a (preferably color-coded) header 441 at the top of the referral 431.

In some embodiments, the systems, methodologies and software disclosed herein may be implemented on one or more computational devices. Such computational devices may include one or more hardware central processing units (CPU) that carry out the functions of the device, and may also comprise an operating system configured to perform executable instructions. Such computational devices may also have the ability to connect to, access or interface with a network, a cloud computing infrastructure, an intranet, and/or one or more data storage devices. Preferably, the computational device is connected to the Internet such that it accesses the World Wide Web.

Suitable computational devices that may be utilized to implement the systems, methodologies and software disclosed herein include, but are not limited to, server computers, desktop computers, laptop computers, notebook computers, sub-notebook computers, netbook computers, netpad computers, set-top computers, handheld computers, Internet appliances, mobile smartphones, tablet computers (including those with booklet, slate, and convertible configurations), personal digital assistants, video game consoles, and vehicles. One skilled in the art will appreciate that various smartphones, televisions, video players, and digital music players with optional computer network connectivity may be suitable for use in implementing the systems, methodologies and software disclosed herein.

In some embodiments, the computational device may include an operating system which is configured to perform executable instructions. Such an operating system may comprise, for example, software (including programs and data) which manages the hardware associated with the computational device and which provides services for the execution of applications. Suitable server operating systems which may be utilized for this purpose may include, but are not limited to, FreeBSD, OpenBSD, NetBSD®, Linux, Apple® Mac OS X Server®, Oracle® Solaris®, Windows Server®, and Novell® NetWare®. Suitable personal computer operating systems which may be utilized for this purpose may include, but are not limited to, Microsoft® Windows®, Apple® Mac OS X®, UNIX®, and UNIX-like operating systems such as GNU/Linux®. Suitable operating systems for smart phones and other mobile communications devices which may be utilized for this purpose may include, but are not limited to, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. In some embodiments of the systems and methodologies described herein, the operating system may be provided, in whole or in part, through cloud computing.

In some embodiments of the systems and methodologies described herein, the computational device may include, or have associated with it, one or more storage and/or memory devices. The storage and/or memory devices may consist of one or more physical devices used to store data or programs on a temporary or permanent basis. In some embodiments of the systems and methodologies described herein, one or more of the storage and/or memory devices may have a volatile memory and may require power to maintain information stored therein.

In other embodiments of the systems and methodologies described herein, the storage and/or memory devices may be equipped with non-volatile memory (such as, for example, flash memory) which retains information stored therein when the computational device is not powered. The non-volatile memory may comprise, for example, dynamic random-access memory (DRAM), ferroelectric random access memory (FRAM) or phase-change random access memory (PRAM).

In some embodiments of the systems and methodologies described herein, the computational device may be equipped with, or in communication with, various storage devices such as, for example, CD-ROMs, DVDs, flash memory devices, magnetic disk drives, magnetic tapes drives, optical disk drives, and cloud computing based storage. In further embodiments, the storage and/or memory device may comprise various combinations or sub-combinations of the foregoing devices.

In some embodiments of the systems and methodologies described herein, the computational device may include a display to communicate information visually to a user. The display may be, for example, a cathode ray tube (CRT) display, a liquid crystal display (LCD), a thin film transistor liquid crystal display (TFT-LCD), an organic light emitting diode (OLED) display, a plasma display, a video display, a heads-up display, or the like.

In some embodiments of the systems and methodologies described herein, the computational device may include or be equipped with one or more input devices to receive information from a user. Such input devices may include, for example, various tactile devices, keyboards, pointing devices (such as, for example, mice, trackballs, track pads, joysticks, game controllers, or styluses), touch screens or multi-touch screens, microphones, video cameras, or various combinations or sub-combinations of the foregoing input devices.

In some embodiments of the systems and methodologies described herein, the computational device may include a non-transitory, computer readable, and preferably tangible storage medium or media which is encoded with a program or other operating instructions that are executable by the operating system of the computational device or by another device that the computational device is in communication with. These instructions may include instructions for the purpose of implementing the systems and methods disclosed herein. In some embodiments, the computer readable storage medium may be removable from the computational device. The computer readable storage medium may include, but is not limited to, CD-ROMs, DVDs, flash memory devices, solid state memory, magnetic disk drives, magnetic tape drives, optical disk drives, cloud computing systems and services, and the like. The program or other operating instructions may be permanently, substantially permanently, semi-permanently, or non-transitorily encoded on the medium or media.

In some embodiments of the systems and methodologies described herein, the computational device may include one or more computer programs in the form of a sequence of instructions which are executable in the computational device's CPU, and which are written to perform a specified task. These computer readable instructions may be implemented as program modules, such as functions, objects, Application Programming Interfaces (APIs), data structures, and the like, that perform particular tasks or implement particular abstract data types, and may be written in various versions of various languages.

In the systems and methodologies described herein, the functionality of the computer program (or programs) or computer readable instructions may be combined or distributed as desired in various environments. For example, any computer program utilized in the systems and methodologies described herein may comprise one or more sequences of instructions which may be provided from one or more locations, and may include one or more software modules. In some embodiments, such a computer program may include, in part or in whole, one or more components selected from the group consisting of web applications, mobile applications, standalone applications, and web browser plug-ins, extensions, add-ins, and add-ons.

In some embodiments of the systems and methodologies described herein, such a computer program may include a web application which, in various embodiments, may utilize one or more software frameworks and one or more database systems. In some embodiments of the systems and methodologies disclosed herein, the web application may be created upon a software framework such as Microsoft®.NET or Ruby on Rails (RoR), and may utilize one or more database systems such as, for example, relational, non-relational, object oriented, associative, or XML database systems. Relational database systems that may be utilized may include, for example, Microsoft® SQL Server, mySQL™, and Oracle®. Moreover, the web application may be written in one or more versions of one or more languages such as, for example, markup languages, presentation definition languages, client-side scripting languages, server-side coding languages, database query languages, or various combinations or sub-combinations thereof.

In some embodiments of the systems and methodologies described herein, the web application may be written at least partially in (a) a markup language such as Hypertext Markup Language (HTML), Extensible Hypertext Markup Language (XHTML), or eXtensible Markup Language (XML); a presentation definition language such as, for example, Cascading Style Sheets (CSS); a client-side scripting language such as, for example, Asynchronous Javascript and XML (AJAX), Flash® Actionscript, Javascript, or Silverlight®; a server-side coding language such as, for example, Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy; or a database query language such as, for example, Structured Query Language (SQL).

In some embodiments of the systems and methodologies described herein, the web application may integrate enterprise server products such as, for example, IBM® Lotus Domino®. The web application may also include a media player element which may utilize one or more suitable multimedia technologies such as, for example, Adobe® Flash®, HTML 5, Apple® QuickTime®, Microsoft® Silverlight®, Java™, or Unity®.

In some embodiments of the systems and methodologies described herein, a computer program may be utilized which includes a mobile application which is provided to a mobile computational device or mobile technology platform. The mobile application may be provided to the mobile computational device at the time it is manufactured or at a later time by way of download over a suitable network. The mobile application may be created by techniques known to the art using hardware, languages, and development environments which are also known to the art, and may be written in several languages. Suitable programming languages include, for example, C, C++, C#, Objective-C, Java™, Javascript, Pascal, Object Pascal, Python™, Ruby, VB.NET, WML, and XHTML/HTML with or without CSS, and various combinations or sub-combinations thereof.

Several mobile application development environments are known to the art and may be utilized in the development of the mobile application. These include, without limitation, AirplaySDK, alcheMo, Appcelerator®, Celsius, Bedrock, Flash Lite, .NET Compact Framework, Rhomobile, WorkLight Mobile Platform, Lazarus, MobiFlex, MoSync, and Phonegap. Several mobile device manufacturers also currently distribute software developer kits including, for example, iPhone and iPad (iOS) SDK, Android™ SDK, BlackBerry® SDK, BREW SDK, Palm® OS SDK, Symbian SDK, webOS SDK, and Windows® Mobile SDK.

Several commercial forums are available for the distribution of mobile applications. These include, for example, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

In some embodiments, the systems and methodologies described herein may utilize a computer program which includes one or more standalone applications. Such standalone applications may be programs that are run as an independent computer process (that is, not as an add-on to an existing process, e.g., not a plug-in). Such standalone applications are often compiled. A compiler is a computer program(s) that transforms source code written in a programming language into binary object code such as assembly language or machine code. Suitable compiled programming languages may include, by way of example, C, C++, Objective-C, COBOL, Delphi, Eiffel, Java™, Lisp, Python™, Visual Basic, and VB .NET. Compilation is often performed, at least in part, to create an executable program. In some embodiments of the systems and methodologies described herein, the computer program may include one or more executable complied applications.

In some embodiments, the systems and methodologies described herein may include software, server, and/or database modules, or use of the same. Such software modules may be created by techniques known to the art (possibly by using machines, software, and languages known to the art), and may be implemented in various ways. These software modules may comprise one or more files, section of codes, programming objects, programming structures, or various combinations or sub-combinations thereof. In some embodiments of the systems and methodologies described herein, the software modules may comprise a web application, a mobile application, and/or a standalone application. The software modules may be present in one or more computer programs or applications, and may be hosted on one or more machines or cloud computing platforms which may be in one or more locations.

In some embodiments, the systems and methodologies described herein may include one or more databases, or use of the same. Such databases may include, for example, relational databases, non-relational databases, object oriented databases, object databases, entity-relationship model databases, associative databases, and XML databases. These databases may be Internet-based, web-based, cloud computing-based, or may be based on one or more local computer storage devices.

Some aspects of embodiments of the systems and methodologies disclosed herein may be found at http://public.zirmed.com/ and http://public.zirmed.com/zirmed-clinical-link/, both of which are incorporated herein by reference in their entirety along with their referenced pages and documents.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A method for exchanging healthcare information between a plurality of healthcare providers, comprising:
providing a software platform;
establishing a communication means on the platform which allows a member healthcare provider to (a) communicate with other member healthcare providers via secure messages, and (b) exchange healthcare related documents with each other as attachments to the messages; and
creating a network associated with a first healthcare provider on the platform by (a) transmitting an invitation initiated by the first healthcare provider to a second healthcare provider inviting the second healthcare provide to join the first healthcare provider's network, (b) receiving an acceptance of the invitation from the second healthcare provider, and (c) authenticating the second healthcare provider.

2. The method of claim 1, wherein the communications means is HIPAA compliant.

3. The method of claim 1, further comprising:
tracking and verifying the transmission and receipt of messages sent from one member healthcare provider to another; and
creating a record of the transmission and receipt of the message.

4. The method of claim 1, further comprising:
tracking and verifying the transmission, receipt and acceptance of documents attached to a message sent from one member healthcare provider to another; and
creating a record of the transmission, receipt and acceptance of the attached documents.

5. The method of claim 1, wherein the platform is prepopulated with the profiles of healthcare providers.

6. The method of claim 5, further comprising:
assigning a prepopulated profile to a healthcare provider via an authentication process, thus establishing the healthcare provider as a member on the platform.

7. The method of claim 6, wherein the authentication process is initiated by a healthcare provider seeking to claim the profile.

8. The method of claim 1, wherein the software platform provides a referral system by which a member can refer patients to another member.

9. The method of claim 8, wherein the software platform provides a referral settings menu in which a member can specify information required for a patient referral made to that member by other members.

10. The method of claim 9 wherein, when a first member makes a patient referral to a second member through the referral system, the first member is presented with a fillable form which contains fields for information requested by the second member, and from which a referral to the second member is generated.

11. The method of claim 10, wherein at least some of the fields are required fields, and wherein the referral system does not send the referral to the second member until all required fields have been completed.

12. The method of claim 10, wherein the referral form includes an attachment function which allows supporting documents to be attached to the referral.

13. A tangible, non-transitory, computer readable medium containing suitable programming instructions which, when acted upon by one or more processors, implements the method of claim 1.
